(19) United States
(12) Patent Application Publication
(10) Pub. No.: US 2018/0319682 A1
(43) Pub. Date: Nov. 8, 2018

(54) Method for optimising material recovery in a chemical pulping process

(71) Applicant: Kemira Oyj, Helsinki (FI)

(72) Inventors: Jonni Ahlgren, Espoo (FI); Sakari Halttunen, Espoo (FI); Jussi Ruotsalainen, Espoo (FI); Kari Saari, Vantaa (FI)

(73) Assignee: Kemira Oyj, Helsinki (FI)

(21) Appl. No.: 15/773,572

(22) PCT Filed: Nov. 4, 2016
(86) PCT No.: PCT/FI2016/050781

§ 371 Date: May 4, 2018

(30) Foreign Application Priority Data
Nov. 4, 2015 (FI) 20155806

(51) Int. Cl. C02F 1/56; D21C 11/00

(52) U.S. Cl. CPC C02F 1/56; D21C 11/0028; C02F 2103/28; D21C 11/0007; D21C 11/0014

(57) ABSTRACT

The invention relates to a method for optimising material recovery in a chemical pulping process. The method comprises treating of cellulosic raw material with cooking chemicals in a cooking step, where lignin is at least partly dissolved into cooking liquid phase and separated from fibres. The lignin is separated from the cooking liquid phase. The separated lignin is used for formation of a treatment composition comprising at the most 1 weight-% of aluminium. A bleaching liquid phase is treated with the treatment composition in order to remove organic humic substances from the bleaching liquid. Organic sludge is formed and it is used for energy production in a chemical recovery step.

The present invention relates to a method for optimising material recovery in a chemical pulping process according to the preamble of the independent claim presented below.

In chemical pulping wood chips are cooked with cooking chemicals, i.e. sodium hydroxide and sodium sulphide. During the cooking lignin and hemicelluloses in the pulp degrade and become soluble in the cooking chemicals. In the end of cooking the liquid phase called black liquor is separated from the fibre phase. Black liquor comprises lignin, carbohydrates from hemicelluloses, used cooking chemicals and inorganic salts. In the recovery process the cooking chemicals are regenerated from the black liquor. Lignin may be separated from the black liquor before recovery of the cooking chemicals.

All undesired organic substances are not separated from the fibres during cooking step but follow with the fibre phase to the succeeding process steps.

The separated fibre phase, i.e. chemical pulp, can be transferred from cooking step to succeeding process steps, where the fibre phase may be washed and bleached. The bleaching sequence of chemical pulp often comprises one or several steps employing oxidizing agent(s) and under bleaching conditions lignin-like substances and possible lignin still contained in the fibre phase are partly dissolved. After bleaching, the fibre phase, i.e. pulp, is washed, dried and the drained excess water is normally transferred to a water treatment unit. Lignin and other similar substances are considered as sparingly biodegradable substances, and they have a great negative influence on the properties of purified waste water. Therefore it would be desirable to be able to remove a dissolved lignin, other lignin type substances and their disintegration products from the waste water of the bleaching and/or washing step(s).

It is known that inorganic coagulants, such as calcium or aluminium or iron based metal salts, precipitate lignin and other organic substances. However, there are problems, such as high inorganic sludge production, related to the use of the inorganic metallic coagulants. Sludge comprising high amounts of inorganic salts is hard to use or deposit. For example, sludge with high inorganic salt concentration may cause problems, such as corrosion, in energy production where the sludge could be used as fuel.

It is an object of the present invention to reduce or even eliminate the above-mentioned problems appearing in prior art.

The object of the present invention is to provide a method for removing humic substances comprising lignin, other lignin-like substances and their disintegration products from wastewaters of bleaching and/or washing step of chemical pulping process.

Another object of the present invention is to provide a method for removing humic substances from wastewaters of bleaching and/or washing step of chemical pulping process, which method reduces an amount of inorganic material in produced sludge.

Yet another object of the present invention is to provide a method for improving the material recovery in a chemical pulping process comprising a bleaching step.

In order to achieve among others the objects presented above, the invention is characterised by what is presented in the enclosed independent claim. Some preferred embodiments of the invention will be described in the dependent claims.

Typical method according to the present invention for optimising material recovery in a chemical pulping process comprises
treating of cellulosic raw material with a liquid phase comprising cooking chemicals in a cooking step, where lignin and optionally other substances are dissolved into cooking liquid phase and separated from fibres,
separating fibres from the said cooking liquid phase, which comprises used cooking chemicals and dissolved substances from wood, such as lignin,
transferring fibres to a bleaching step, where the fibres are brought into contact with bleaching chemical(s), and separating the bleached fibres from the bleaching liquid phase,
separating lignin from the cooking liquid phase,
recovering the cooking chemicals from the cooking liquid phase in a chemical recovery step and circulating the recovered cooking chemicals back to the cooking step,
using separated lignin for formation of a treatment composition comprising at the most 1 weight-% of aluminium, calculated on basis of the weight of dry lignin in the composition,
treating the bleaching liquid phase with the treatment composition and removing of organic humic substances, preferably recalcitrant organic substances, from the bleaching liquid phase and forming organic sludge, and
using the organic sludge for energy production in the chemical recovery step.

Now it has been surprisingly found out that the humic substances can be easily removed from a bleaching liquid phase, which is wastewater from chemical pulp bleaching and/or washing, by using a treatment composition comprising separated lignin, which is enhanced by modification. The modification can be done, for example, by cationisation or by allowing the separated lignin to interact with a small amount of aluminium. This enhanced modified lignin effectively precipitates humic substances, such as dissolved lignin and its disintegration products in the waste water streams of the chemical pulp bleaching. The obtained sludge has high solids content and comprises only minute amounts of inorganic salts. Thus the use of lignin for precipitation of humic substances reduces remarkably the amount of the inorganic salts in the resulting high solids sludge in comparison to the prior art solutions, which use aluminium or iron based inorganic metal salts for formation of sludge. Furthermore, the lignin separated from the black liquor can be effectively used for recovery of similar organic substances from other process streams, to increase the recovery of humic substances from the pulp production process as a whole and to increase the energy recovery of the process.

In the present application the term “recalcitrant organic substances” is understood as organic substances that resist microbial degradation, are difficult to oxidize biochemically and/or are not readily biodegradable. Examples of such compounds are humic substances, such as wood-based lignin and its degradation products, large aromatic compounds and phenolic compounds, such as polyphenols.

In the present application the term “humic substances” is understood as organic substances originating from chemical pulping process of cellulosic fibre material such as wood and other plant materials, especially wood material. Thus, humic substances refer to organic substances comprising lignin itself, lignin-like compounds and their disintegration products as well as other organic compounds existing in wastewaters of bleaching and/or washing step(s) of chemical pulp after cooking step.

In the present application the term “bleaching liquid phase” compasses liquid phase which is separated from fibres at the bleaching step or at the washing steps immediately after the bleaching step. The term thus encompasses wastewaters from bleaching and from washing of bleached fibres.

Especially lignin is at least partly dissolved and/or disintegrated during pulp bleaching. Thus, the method according to the invention is used for removing of the dissolved lignin or dissolved disintegration products of lignin from an aqueous bleaching liquid phase such as effluent from chemical pulp bleaching.

According to one preferred embodiment of the invention the treatment composition comprises separated lignin, which is cationised. It has been observed that the cationised lignin effectively interacts with humic substances and/or recalcitrant substances in the wastewaters of chemical pulp bleaching and/or washing and removes them from the liquid phase into the sludge which is formed. Separated lignin from the black liquor may be cationised by reacting lignin with a cationisation chemical and/or compound. Suitable, preferable cationisation chemicals and/or compounds are, for example, glycidyltrimethylammonium chloride, 2,3-epoxypropyltrimethylammonium chloride and N-(3-chloro-2-hydroxypropyl)trimethylammonium chloride. More preferably cationisation chemical or compound is 2,3-epoxypropyltrimethylammonium chloride and N-(3-chloro-2-hydroxypropyl)trimethylammonium chloride. Suitable cationised lignin can be prepared as described in patent SE 503057. In principle, any cationised lignin may be suitable for use in the present invention.

According to one preferred embodiment of the invention the treatment composition comprises separated lignin, which is modified by interaction with a small amount of aluminium. It is assumed that the small amount of aluminium provides an effect which is similar to the cationisation of the separated lignin as described above.

The treatment composition may comprise a small amount of aluminium, especially if the modification of the separated lignin is done by small amount of aluminium. The aluminium may originate from modification of the separated lignin, or aluminium may be used as enhancer with separated cationised lignin. It has been observed that a small amount of aluminium may enhance the function of the separated lignin in precipitating lignin and forming organic sludge with low content of inorganic material. The aluminium may be introduced to the treatment composition in form of (poly)aluminium chloride, (poly)aluminium sulphate, aluminium chlorohydrate, aluminium triformate or the like. Preferably the amount of aluminium in the treatment composition is low. The treatment composition comprises at the most 1 weight-% of aluminium, preferably at the most 0.7 weight-% of aluminium, more preferably at the most 0.5 weight-% of aluminium, even more preferably at the most 0.25 weight-% of aluminium, calculated on basis of the weight of dry lignin in the composition According to one preferred embodiment of the present invention the treatment composition is completely free of aluminium.

According to one embodiment of the invention it is also possible to add, in addition of the treatment composition, at least one flocculating agent, such as polyacrylamide, to bleaching liquid phase for increasing flock size to be formed and for improving the separation of the precipitated organic humic substances from the liquid phase. The flocculating agent is added before the separation of the precipitated organic humic substances. The addition of flocculating agent may be carried out simultaneously with the addition of the treatment composition, or it may be added sequentially with the treatment composition. The flocculating agent may be added directly to the bleaching liquid phase, or it may be added first to an aqueous process flow which is later combined with said bleaching liquid phase. According to an embodiment of the invention the flocculating agents are polymeric flocculants, such as modified polyacrylamides.

According to one embodiment of the invention the aqueous bleaching liquid phase, e.g. wastewater or effluent from chemical pulp bleaching, which is treated with the treatment composition has a pH value under 7, preferably under 5, more preferably under 3. According to one embodiment of the invention the pH of the bleaching liquid phase is in the range of 1-5, preferably 1.5-3. The present invention especially relates to removal of organic humic substances from wastewater streams of chemical pulp bleaching. According to one embodiment of the invention no adjustment of the pH value of the bleaching liquid phase is needed before the addition of the treatment agent comprising lignin to the bleaching liquid phase. Thus, the method according to one preferable embodiment of the invention is free of any pH adjustment steps. Preferably, the pH during the removal of organic humic compounds changes at the most 2, preferably at the most 1, pH units.

According to one embodiment of the invention, it is preferable to add the treatment composition comprising lignin directly to bleaching liquid phase, e.g. wastewater stream containing humic substances such as dissolved lignin, for precipitating the organic humic substances. The adequate amount of the treatment agent to be added is dependent on the solution or process flow to be treated. According to a preferred embodiment of the invention, the method is used for solutions or process flows where the COD value of the untreated solution, such as untreated bleaching liquid phase, or process flow is over 1000 g/m³, preferably over 2000 g/m³. According to an embodiment of the invention the method is used for solutions or process flows where the COD of the untreated solution or process flow is in the range of 1000-5000 g/m³, preferably 2000-3000 g/m³. In an embodiment of the invention, the treatment composition is dosed in amount providing a lignin dose 0.05-2 g/g COD, preferably 0.1-1 g/g COD. In an embodiment of the invention the treatment composition is added to the aqueous bleaching liquid phase in an amount from 0.25 to 10 g lignin/g C of humic substances, more preferably from 0.5 to 5 lignin g/g C of humic substances.

According to one embodiment of the invention the inorganic content of the organic sludge is less than 30 weight-%, preferably less than 10 weight-%. Thus it is possible to obtain sludge with solids content that mainly comprises organic substances. This sludge can be easily and effectively used as fuel in incinerators or the like, for example in cooking chemical recovery. It is possible that the organic sludge produced with the method according to the invention may be essentially free of inorganic metal compounds, especially aluminium and iron compounds.

In a preferred embodiment of the invention the bleaching liquid phase is a filtrate from the chemical pulp bleaching, and the treatment composition comprising lignin can be added directly to the filtrate flow. In this manner the precipitation of the organic humic substances can be easily carried out before wastewater treatment process.

The method according to an embodiment of the invention may further comprise separation of the precipitated humic substances, i.e. formed organic sludge, from the bleaching liquid phase. The separation of precipitated solids, i.e. formed organic sludge, is carried out before conveying the bleaching liquid phase to the waste water treatment. The precipitated solids are typically removed from the solution by using disk filter, dissolved air flotation, settling tank or membrane filtration. The reject, i.e. an organic sludge, comprising the precipitated organic substances can be conveyed to black liqueur incinerator or in primary sedimentation prior to biological waste water treatment. The sludge produced by the method according to the invention is highly organic and therefore the end-disposal can be done with existing incinerators. Thus, the removal of organic substances, such as lignin, upstream of actual waste water treatment may make the tertiary treatment of the waste water unnecessary. In this manner additional investment costs may be avoided.

### Experimental

An embodiment of the invention is more closely described in the following non-limiting example.

### EXAMPLE

Coagulation and flocculation tests for COD removal from bleaching filtrate were carried out in a laboratory of a Scandinavian kraft mill. Tests were carried out with mixed fresh wastewater samples of 5.0 litres from alkaline bleaching filtrate line and 4.7 litres from acid bleaching filtrate lines. Temperature of both samples in experiments was ca. 60° C.

Tests were done with Jar test equipment Kemira Flocculator 2000 with batch sizes 500 ml. The Jar test equipment was operated in generic step-wise manner:
fast mixing, e.g. 10 seconds at 350 rpm; coagulant addition in the beginning);
slow stirring, e.g. 5 minutes at 40 rpm; flocculant addition at the end); and
sedimentation, e.g. 15 minutes.

The coagulants used in the test procedure were

a) inorganic aluminium coagulant (Fennofloc A100, Kemira Oyj), dose 186 g Al/m³, and
b) experimental cationised lignin product: charge density 2.2 meq/g at pH 4, 1.5 meq/g at pH 7.5; dose 200 g lignin/m³, calculated as lignin dry solids.

Flocculant was

a) nonionic polymer from Fennopol N series (Kemira Oyj), dose 1.0 g DS/m³, with inorganic aluminium coagulant (Fennofloc A100, Kemira Oyj); and
b) cationic polymer from Fennopol K series (Kemira Oyj), dose 1.0 g DS/m³, with experimental cationised lignin product.

In the mill laboratory turbidity, pH and total COD_{cr} were analysed from the supernatant, as well as UV-absorption at 245 nm and filtered COD_{cr} were analysed from supernatant filtered with 0.45 μm filter. Dissolved organic carbon, DOC, from filtered sample were later analysed with LC-OCD in laboratory. Total DOC is the sum of all dissolved organic carbon. Humic DOC is the subfraction of total DOC and it is determined with specific molecular size and UV-absorbance at 254 nm. Experimental results of treated and untreated samples are shown in Table 1. The test results indicate that soluble organic COD removal is possible with cationised lignin product.

TABLE 1
Jar test results.

| | | | Reference | |
|---|---|---|---|---|
| | | | sample, | |
| | Reference | | for | |
| | sample, | Inorganic | cationised | Cationised |
| | for inorganic | Al | lignin | lignin |
| | Al coagulant | coagulant | coagulant | coagulant |
| pH | 5 | 4.2 | 5 | 5.2 |
| Turbidity, NTU | 38 | 16 | 102 | 18 |
| UV-absorption | 4.3 | 3.7 | 4.0 | 3.9 |
| at 254 nm | | | | |
| Total DOC_{filt}, g/m³ | 850 | 530 | | 770 |
| Humic DOC_{filt}, | 430 | 180 | | 390 |
| g/m³ | | | | |
| COD_{Cr}, _{filt}, g/m³ | 2220 | 1250 | 2100 | 1790 |
| COD_{Cr, filt} | | 44% | | 15% |
| removed | | | | |
| COD_{Cr}, _{filt} | | | | 1.55 |
| removal g/g lignin | | | | |

Even if the invention was described with reference to what at present seems to be the most practical and preferred embodiments, it is appreciated that the invention shall not be limited to the embodiments described above, but the invention is intended to cover also different modifications and equivalent technical solutions within the scope of the enclosed claims.

1. A method for optimising material recovery in a chemical pulping process, the method comprising
treating of cellulosic raw material with a liquid phase comprising cooking chemicals in a cooking step, where lignin and optionally other substances are at least partly dissolved into cooking liquid phase and separated from fibres,
separating fibres from the said cooking liquid phase, which comprises used cooking chemicals and dissolved substances from wood, such as lignin,
transferring fibres to a bleaching step, where the fibres are brought into contact with bleaching chemical(s), and separating the bleached fibres from the bleaching liquid phase,
separating lignin from the cooking liquid phase,
recovering the cooking chemicals from the cooking liquid phase in a chemical recovery step and circulating the recovered cooking chemicals back to the cooking step,
characterised in
using separated lignin for formation of a treatment composition comprising at the most 1 weight-% of aluminium, calculated on basis of the weight of dry lignin in the composition,
treating the bleaching liquid phase with the treatment composition and removing of organic humic substances, preferably recalcitrant organic substances, from the bleaching liquid and forming organic sludge,
using the organic sludge for energy production in the chemical recovery step.

2. The method according to claim 1, in wherein the separated lignin is cationised.

3. The method according to claim 2, wherein separated lignin is cationised by reacting lignin with a cationisation chemical and/or compound selected from glycidyltrimethylammonium chloride, 2,3-epoxypropyltrimethylammonium chloride and N-(3-chloro-2-hydroxypropyl)-trimethylammonium chloride.

4. The method according to claim 1, wherein the treatment composition is free of aluminium.

5. The method according to claim 1, wherein the treatment composition comprises aluminium at the most 0.7 weight-%, preferably at the most 0.5 weight-%, calculated on basis of the weight of dry lignin in the composition.

6. The method according to claim 1, wherein the aqueous bleaching liquid phase, which is treated with the treatment composition has a pH value under 7, preferably at the most 5, more preferably at the most 3.

7. The method according to claim 1, wherein the method is free of any pH adjustment steps.

8. The method according to claim 1, wherein the pH during the removal of organic humic substances changes at the most 2, preferably at the most 1, pH units.

9. The method according to claim 1, wherein the inorganic content of the organic sludge is less than 30 weight-%, preferably less than 10 weight-%.

10. The method according to claim 1, wherein untreated bleaching liquid phase has a COD value, which is over 1000 g/m³, preferably over 2000 g/m³.

11. The method according to claim 1, wherein the treatment composition is dosed in amount, which provides a lignin dose 0.05-2 g/g COD, preferably 0.1-1 g/g COD.

12. The method according to claim 1, wherein at least one flocculating agent, such as polyacrylamide, is added to bleaching liquid phase.

13. The method according to claim 12, wherein flocculating agent is added simultaneously or sequentially with the treatment composition.
